(19) United States
(12) Patent Application Publication
(10) Pub. No.: US 2024/0097246 A1
(43) Pub. Date: Mar. 21, 2024

(54) BATTERY MODULE AND METHOD OF PRODUCING THE SAME

(71) Applicant: TOYOTA JIDOSHA KABUSHIKI KAISHA, Toyota-shi Aichi-Ken (JP)

(72) Inventor: Chikayuki KUBO, Nagoya-shi Aichi-Ken (JP)

(73) Assignee: TOYOTA JIDOSHA KABUSHIKI KAISHA, Toyota-shi Aichi-Ken (JP)

(21) Appl. No.: 18/237,006

(22) Filed: Aug. 23, 2023

(30) Foreign Application Priority Data
Sep. 15, 2022 (JP) 2022-147363

(51) Int. Cl. H01M 50/119; H01M 10/0585; H01M 50/103; H01M 50/124

(52) U.S. Cl. CPC H01M 50/119; H01M 10/0585; H01M 50/103; H01M 50/124

(57) ABSTRACT

Provided is a battery module that enables a large current to be taken out thereof, that can suppress permeation of gas and moisture with a simple structure, and that can be easily produced. The battery module includes: an electricity storage module; and a housing, wherein the housing has a pair of sheet-shaped structures, the sheet-shaped structures each include a metal sheet that is disposed over an end face of the electricity storage module in the thickness direction, and a laminated sheet that is disposed so as to surround the periphery of the metal sheet, the metal sheet is electrically connected to the electricity storage module, an inner side surface of the laminated sheet is joined to a side surface of the metal sheet, and in a pair of the sheet-shaped structures, outer circumferential parts of the laminated sheets are directly or indirectly joined to each other.

### CROSS-REFERENCE TO RELATED APPLICATIONS

This application is based upon and claims the benefit of priority of the prior Japanese Patent Application No. 2022-147363, filed on Sep. 15, 2022, the entire contents of which are incorporated herein by reference.

### FIELD

The present application relates to a battery module and a production method thereof.

### BACKGROUND

It is known that penetration of moisture through a nonaqueous secondary battery containing a nonaqueous electrolyte degrades the nonaqueous electrolyte and the battery performance. Therefore, it is necessary to suppress penetration of moisture through the battery. For example, patent literature 1 discloses the battery that can suppress penetration of moisture therethrough.

To increase output is also one problem in the battery fields. Generally, a secondary battery is provided with an electrode terminal which protrudes from the side surface thereof and via which a current is taken out. However, a large current cannot be taken out of the electrode terminal provided on the side surface of the battery because the area of the terminal is small, which is problematic. For this problem, the following art is known: both the end faces of an electrode body are provided with current collectors (terminals), whereby the areas of the terminals are enlarged, which allows a large current to be taken out. For example, patent literatures 2 and 3 each disclose such an art.

Patent literature 2 discloses an electricity storage module provided with a stack, and a reinforcement member provided on the stack, the stack comprising: a first electrode including a first current collector, and a first active material layer provided on a first face of the first current collector; a second electrode including a second current collector, and a second active material layer provided on a second face of the second current collector, having a polarity different from the first active material layer, and layered on the first active material layer, so that the second active material layer faces the first active material layer; and a frame-shaped spacer provided between the first current collector and the second current collector so as to surround the first active material layer and the second active material layer looking in the layering direction of the first electrode and the second electrode, and being for closing the space between the first current collector and the second current collector, wherein the spacer includes a first inner side surface that faces the space, and a first outer side surface on the opposite side of the first inner side surface, and the reinforcement member is provided all over the periphery of the outer side surface so as to cover the outer side surface, and has a metal layer disposed along the outer side surface.

According to patent literature 2, a large current can be taken out of an end face of the electricity storage module; further, permeation of gas and moisture can be suppressed because the reinforcement member having the metal layer is disposed all over the side surface of the electricity storage module.

Patent literature 3 discloses a lithium ion battery module provided with a first metal sheet, an electricity storage element, and a second metal sheet in this order, the electricity storage element comprising a lithium ion single cell such that a cathode current collector, a cathode active material layer, a separator, an anode active material layer, and an anode current collector are layered in this order, the cathode current collector and the anode current collector are the outermost layers thereof, and the cathode active material layer and the anode active material layer are sealed around the peripheries thereof, whereby an electrolytic solution is sealed therein, wherein the lithium ion battery module has an electroconductive elastic member that is disposed between the first metal sheet and the cathode current collector that is the outermost layer of the electricity storage element, and/or between the second metal sheet and the anode current collector that is the outermost layer of the electricity storage element, and the first metal sheet and the second metal sheet are insulated from each other. Patent literature 3 also discloses a lithium ion battery module provided with a battery housing that houses the electricity storage element therein, the battery housing comprising a first metal sheet and a second metal sheet, wherein the first metal sheet and the second metal sheet each has a contacting face in contact with the elastic member(s), and an exposed face exposed to the outside of the battery housing.

According to patent literature 3, a large current can be taken out of an end face of the electricity storage module, and further, permeation of gas and moisture can be suppressed by housing the electricity storage element in the battery housing comprising the first metal sheet and the second metal sheet.

### CITATION LIST

### Patent Literature

Patent Literature 1: JP 2019-53892 A
Patent Literature 2: JP 2022-27201 A
Patent Literature 3: JP 2021-34141 A

### SUMMARY

### Technical Problem

As described above, the electricity storage modules disclosed in patent literatures 2 and 3 each allow a large current to be taken out of an end face thereof, and can prevent gas and moisture from permeating the battery.

However, in patent literature 2, the spacer is formed over the side surface of the electricity generation component, and further, the supporting member is disposed all over the periphery of the spacer. When the supporting member is disposed, it may be necessary to use a resin that is compatible with the spacer as an adhesive. That is, there is a certain difficulty in the sealing step for the purpose of suppressing permeation of gas and moisture.

In the electricity storage module of patent literature 3, laminated sheets with exposed metal layers are used as the housing. Thus, there is a certain difficulty in the step of exposing the metal layers. For example, patent literature 3 discloses that the metal layers are exposed by subjecting the laminated sheets to solvent treatment, heat treatment, flame treatment, or the like.

### Solution to Problem

As one aspect for solving the above problems, the present disclosure is provided with a battery module comprising: an electricity storage module formed by alternately layering electrodes and electrolyte layers; and a housing that houses the electricity storage module therein, wherein the housing has a pair of sheet-shaped structures that are disposed so as to hold the electricity storage module on both sides in a thickness direction, the sheet-shaped structures each include a metal sheet that is disposed over an end face of the electricity storage module in the thickness direction, and a laminated sheet that is disposed so as to surround a periphery of the metal sheet, the metal sheet is electrically connected to the electricity storage module, an inner side surface of the laminated sheet is joined to a side surface of the metal sheet, and in a pair of the sheet-shaped structures, outer circumferential parts of the laminated sheets are directly or indirectly joined to each other.

In the battery module, the housing may include a frame-shaped member that is disposed so as to surround a periphery of the electricity storage module, and the outer circumferential part of the laminated sheet of one of a pair of the sheet-shaped structures may be joined to one face of the frame-shaped member, and the outer circumferential part of the laminated sheet of the other one of the sheet-shaped structures may be joined to another face of the frame-shaped member. The metal sheet may be thicker than the laminated sheet. Further, the electricity storage module may be a bipolar electricity storage module.

As one aspect for solving the above problems, the present disclosure is provided with a method of producing a battery module, the method comprising: first joining of disposing a laminated sheet around a metal sheet, and joining an inner side surface of the laminated sheet and a side surface of the metal sheet to obtain a sheet-shaped structure; disposing of holding, by a pair of the sheet-shaped structures, an electricity storage module that is formed by alternately layering electrodes and separators in a thickness direction, and disposing the metal sheets over end faces of the electricity storage module in the thickness direction; and second joining of directly or indirectly joining outer circumferential parts of the laminated sheets of a pair of the sheet-shaped structures to each other after said disposing.

### Effects

A large current can be taken out of an end face of the battery module according to the present disclosure because the metal sheets are disposed on the end faces of the electricity storage module in the thickness direction. The battery module according to the present disclosure is such that the electricity storage module is sealed in the housing by the use of a pair of the laminated sheets to which the metal sheets are joined, and thus, can prevent gas and moisture from permeating the housing with a simple structure. Further, the battery module according to the present disclosure can be easily produced because the metal sheets are members different from the laminated sheets, and the sheet-shaped structures can be easily formed by joining these sheets.

The method of producing a battery module according to the present disclosure enables the above-described battery module to be produced with simple steps without any complicated step.

### BRIEF DESCRIPTION OF DRAWINGS

FIG. 1 is a plan view of a battery module 100;

FIG. 2 is a cross-sectional view of the battery module 100 taken along the line II-II of FIG. 1;

FIG. 3 is a cross-sectional view of an end part of the electricity storage module 10;

FIG. 4A shows a laminated sheet 23 formed of one laminated sheet;

FIG. 4B shows the laminated sheet 23 obtained by joining a pair of laminated sheets X each of which is half the size of the laminated sheet 23 taken along the length direction;

FIG. 5 is a cross-sectional view of a battery module 200;

FIG. 6 is a cross-sectional view of a battery module 300;

FIG. 7 is a cross-sectional view of a battery module 400;

FIG. 8 is a flowchart of a method of producing the battery module 100;

FIG. 9A is a schematic view of a first joining step of the method of producing the battery module 100;

FIG. 9B is another schematic view of the first joining step of the method of producing the battery module 100;

FIG. 9C is a schematic view of a disposing step of the method of producing the battery module 100;

FIG. 9D is a schematic view of a second joining step of the method of producing the battery module 100;

FIG. 10A is a schematic view of a first joining step of the method of producing the battery module 200;

FIG. 10B is another schematic view of the first joining step of the method of producing the battery module 200;

FIG. 10C is a schematic view of a disposing step of the method of producing the battery module 200;

FIG. 10D is a schematic view of a second joining step of the method of producing the battery module 200;

FIG. 11A is a schematic view of a first joining step of the method of producing the battery module 300;

FIG. 11B is another schematic view of the first joining step of the method of producing the battery module 300;

FIG. 11C is a schematic view of a disposing step of the method of producing the battery module 300;

FIG. 11D is a schematic view of a second joining step of the method of producing the battery module 300;

FIG. 12A is a schematic view of a first joining step of the method of producing the battery module 400;

FIG. 12B is another schematic view of the first joining step of the method of producing the battery module 400;

FIG. 12C is a schematic view of a disposing step of the method of producing the battery module 400; and

FIG. 12D is a schematic view of a second joining step of the method of producing the battery module 400.

### DESCRIPTION OF EMBODIMENTS

[Battery Module]

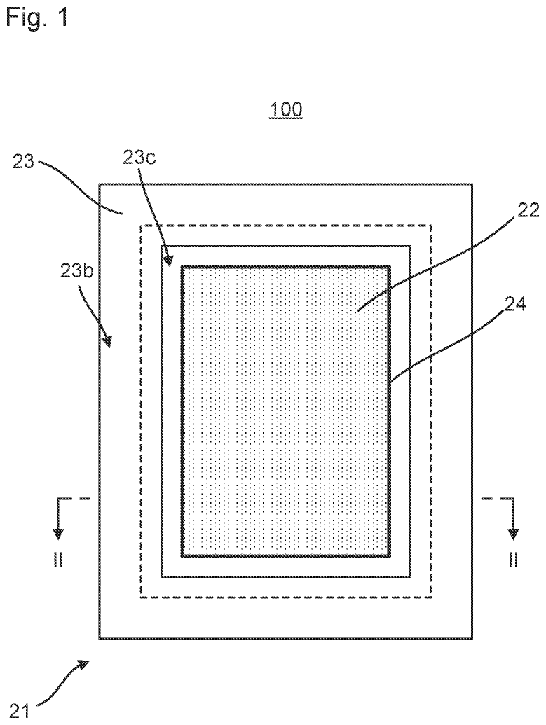

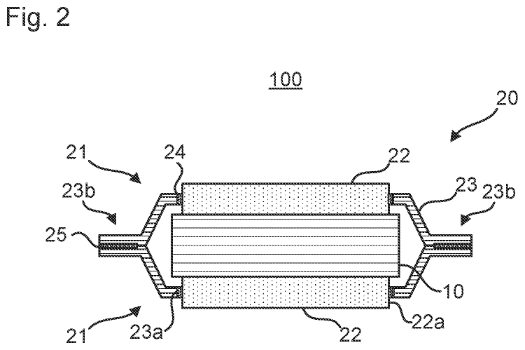

A battery module 100 according to one embodiment of the present disclosure will be described. FIG. 1 is a plan view of the battery module 100. FIG. 2 is a cross-sectional view of the battery module 100 taken along the line II-II of FIG. 1.

As shown in FIGS. 1 and 2, the battery module 100 is provided with an electricity storage module 10 and a housing 20. The electricity storage module 10 is such that electrodes and separators are alternately layered, and the housing 20 houses the electricity storage module 10 therein.

<Electricity Storage Module 10>

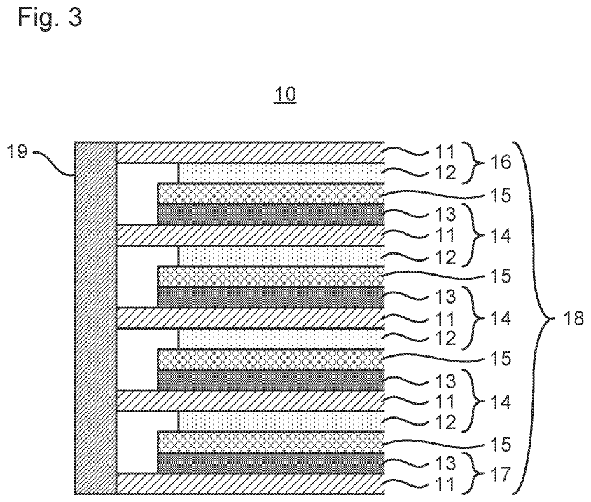

The electricity storage module 10 is formed of alternately layered plural electrodes and plural electrolyte layers. The electricity storage module 10 may be a nonaqueous secondary battery, and may be an all-solid-state secondary battery. The electricity storage module 10 may be a bipolar electricity storage module. The following is the case where the electricity storage module 10 is a bipolar nonaqueous lithium-ion battery. FIG. 3 is a cross-sectional view of an end part of the electricity storage module 10.

The electricity storage module 10 is provided with an electrode stack 18 and a sealing member 19 that is provided all over the side surface of the electrode stack 18. The electricity storage module 10 is also provided with an electrolytic solution thereinside. Each structure will be hereinafter described.

(Electrode Stack 18)

The electrode stack 18 is formed of alternately layered plural bipolar electrodes 14 and plural separators 15. The number of the bipolar electrodes 14 and the number of the separators 15 may be appropriately set according to the target battery performance without any particular limitations. The electrode stack 18 further includes an end part cathode 16 disposed on one end thereof in the layering direction, and an end part anode 17 disposed on the other end thereof.

The bipolar electrodes 14 are each provided with a current collector 11, a cathode layer 12 disposed over one side of the current collector 11, and an anode layer 13 disposed over the other side of the current collector 11. As described, each bipolar electrode 14 is provided with electrode layers of different poles over the respective sides of the current collector 11.

The current collector 11 is a sheet-shaped electroconductive member. An example of the current collector 11 is a sheet of metal foil of stainless steel, iron, copper, aluminum, titanium, or nickel. The metal foil may be made from an alloy including two or more of these metals. The metal foil may be surface-treated in a predetermined way, for example, may be plated. The current collector 11 may be formed of a plurality of sheets of the metal foil. In this case, the sheets of the metal foil may be joined to each other with an adhesive or the like, and may be joined to each other by pressing or the like. The shape of the current collector 11 is not particularly limited, and may be, for example, substantially rectangular. The thickness of the current collector 11 is not particularly limited, and is, for example, 5 μm to 70 μm.

The cathode layer 12 includes a cathode active material. This cathode active material may be appropriately selected from known materials according to the target battery performance without any particular limitations. Examples of a cathode active material as used herein include complex oxides, metallic lithium, and sulfur. For example, the composition of a complex oxide as used herein includes lithium, and at least one of iron, manganese, titanium, nickel, cobalt, and aluminum. An example of a complex oxide as used herein is olivinic lithium iron phosphate (LiFePO₄).

The cathode layer 12 may optionally include a conductive additive. This conductive additive may be appropriately selected from known materials according to the target battery performance without any particular limitations. Examples of a conductive additive as used herein include carbon materials such as acetylene black, carbon black and graphite.

The cathode layer 12 may optionally include a binder. This binder may be appropriately selected from known materials according to the target battery performance without any particular limitations. Examples of a binder as used herein include fluorine-containing resins such as polyvinylidene fluoride, polytetrafluoroethylene, and fluorocarbon rubber; thermoplastic resins such as polypropylene and polyethylene; imide resins such as polyimide and polyamideimide; acrylic resins such as alkoxysilyl group—containing resins and poly(meth)acrylate; styrene-butadiene rubber (SBR); carboxymethyl cellulose; alginates such as sodium alginate and ammonium alginate; water-soluble cellulose ester crosslinked products; and starch-acrylic acid graft polymers.

The shape of the cathode layer 12 is not particularly limited, and may be substantially rectangular. The thickness of the cathode layer 12 is not particularly limited, and, for example, ranges from 1 μm to 1 mm. The area of the cathode layer 12 may be smaller than the anode layer 13. The content of each material in the cathode layer 12 may be appropriately set according to the target battery performance without any particular limitations. The cathode layer 12 may include any materials other than the foregoing materials.

The anode layer 13 includes an anode active material. This anode active material may be appropriately selected from known materials according to the target battery performance without any particular limitations. Examples of an anode active material as used herein include carbons such as graphite, artificial graphite, highly oriented graphite, mesocarbon microbeads, hard carbon, and soft carbon; metallic compounds; elements that can be each alloyed with lithium, and compounds thereof; and boron-doped carbon. Examples of an element that can be alloyed with lithium as used herein include silicon and tin.

The anode layer 13 may optionally include a conductive additive. This conductive additive may be appropriately selected from known materials according to the target battery performance without any particular limitations. For example, one may appropriately select a conductive additive as used herein from conductive additives that can be used for the cathode layer 12.

The anode layer 13 may optionally include a binder. This binder may be appropriately selected from known materials according to the target battery performance without any particular limitations. For example, one may appropriately select a binder as used herein from binders that can be used for the cathode layer 12.

The shape of the anode layer 13 is not particularly limited, and may be substantially rectangular. The thickness of the anode layer 13 is not particularly limited, and, for example, ranges from 1 μm to 1 mm. The area of the anode layer 13 may be larger than the cathode layer 12 in view of increasing output. The content of each material in the anode layer 13 may be appropriately set according to the target battery performance without any particular limitations. The anode layer 13 may include any materials other than the foregoing materials.

A known method may be employed for producing each bipolar electrode 14 without any particular limitations. For example, one may mix the materials to constitute an electrode layer (cathode layer 12 or anode layer 13) in a mortar, and press the mixture to obtain the electrode layer, and dispose the obtained electrode layer on any side of the current collector 11. Alternatively, one may mix the materials to constitute an electrode layer with a solvent to obtain a slurry, and thereafter, apply this slurry to any side of the current collector 11 and dry the resultant.

The respective separators 15 are disposed between every two adjacent bipolar electrodes 14, between the bipolar electrode 14 and the end part cathode 16, and between the bipolar electrode 14 and the end part anode 17. Each separator 15 is a sheet-shaped member that prevents the electrode layers from short-circuiting. The material of the separator 15 is not particularly limited, and examples thereof include porous films and nonwoven fabrics which are made from polyolefin-based resins such as polyethylene (PE) and polypropylene (PP). The shape of the separator 15 is not particularly limited, and may be substantially rectangular. The thickness of the separator 15 is not particularly limited, and, for example, ranges from 1 μm to 1 mm.

Each separator 15 is impregnated with a nonaqueous electrolyte, and thereby, functions as an electrolyte layer. This nonaqueous electrolyte includes a nonaqueous solvent and an electrolyte (supporting salt). This nonaqueous solvent is not particularly limited. Examples of a nonaqueous solvent as used herein include cyclic carbonates, cyclic esters, chain carbonates, chain esters, and ethers. Examples of a supporting salt as used herein include lithium salts. Examples of a lithium salt as used herein include LiBF₄, LiPF₆, LiN(FSO₂)₂, LiN(SO₂CF₃)₂, and LiN(SO₂C₂F₅)₂. Such a nonaqueous solvent may be used individually or a plurality of such nonaqueous solvents may be used in combination. Such a supporting salt may be used individually or a plurality of such supporting salts may be used in combination.

The end part cathode 16 has another current collector 11 and another cathode layer 12 that is disposed over one side of this current collector 11. The end part cathode 16 is disposed on one end of the electrode stack 18 in the layering direction. Specifically, the end part cathode 16 is layered on the separator 15, so that the cathode layer 12 of the end part cathode 16 faces the anode layer 13 of the bipolar electrode 14.

The end part anode 17 has another current collector 11 and another anode layer 13 that is disposed over one side of the current collector 11. The end part anode 17 is disposed on the other end of the electrode stack 18 in the layering direction. Specifically, the end part anode 17 is layered on the separator 15, so that the anode layer 13 of the end part anode 17 faces the cathode layer 12 of the bipolar electrode 14.

A known method may be appropriately employed for the method of producing the end part cathode 16 and the end part anode 17 without any particular limitations. For example, the same method as the aforementioned method of producing each bipolar electrode 14 may be employed.

(Sealing Member 19)

The sealing member 19 is provided all over the side surface of the electrode stack 18. The sealing member 19 is a member that holds the plural bipolar electrodes 14, the end part cathode 16, and the end part anode 17, and is an insulating resin. The sealing member 19 is also a member for sealing the electrolytic solution in the internal space of the electricity storage module.

Examples of the material of the sealing member 19 include heatproof resin members. Examples of a heatproof resin member as used herein include polyimide, polypropylene (PP), polyphenylene sulfide (PPS), modified polyphenylene ether (modified PPE), and PA66.

(Method of Producing Electricity Storage Module 10)

One example of the method of producing the electricity storage module 10 will be described. First, sheet-shaped sealing members (sealing member sheets) are disposed on the current collectors 11 that are to be included in the bipolar electrodes 14, the end part cathode 16, and the end part anode 17 in advance. Specifically, sealing member sheets are disposed so as to surround the peripheries of the current collectors 11 to be joined to the current collectors 11. Next, the bipolar electrodes 14, the end part cathode 16, and the end part anode 17 are produced by the use of the current collectors 11 where the sealing member sheets are disposed. The obtained electrodes and the separators 15 are layered to produce the electrode stack 18. Subsequently, the plural sealing member sheets provided over the side surface of the electrode stack 18 are joined to each other to form the sealing member 19. A nonaqueous electrolyte is poured into the internal space of the sealed electricity storage module 10, and thereby, the electricity storage module 10 is obtained. The method of joining the sealing member sheets is not particularly limited, and an example thereof is heat welding. For example, patent literature 2 discloses an electricity storage module of such a structure.

<Housing 20>

The housing 20 is a member that houses the electricity storage module 10 therein. As shown in FIG. 2, the housing 20 has a pair of sheet-shaped structures 21, 21 that are disposed so as to hold the electricity storage module 10 therebetween in the thickness direction.

(Sheet-Shaped Structure 21)

Each sheet-shaped structure 21 has a metal sheet 22 disposed over an end face of the electricity storage module 10 in the thickness direction, and a laminated sheet 23 disposed so as to surround the periphery of the metal sheet 22. As described above, the electricity storage module 10 is held between a pair of the sheet-shaped structures 21, 21. Here, when focusing on the electricity storage module 10, the metal sheets 22, 22 are disposed over the end faces on one and the other sides of the electricity storage module 10 in the thickness direction. As shown in FIG. 2, the laminated sheet 23 may be formed in each sheet-shaped structure 21 as appropriate according to the shape of the electricity storage module 10 in order for the electricity storage module 10 to be allowed to be housed.

(Metal Sheet 22)

The metal sheet 22 is layered over each end face of the electricity storage module 10 in the thickness direction, and is electrically connected to the electricity storage module 10. Specifically, the metal sheet 22 is electrically connected to the current collector 11 of the end part cathode 16 or the end part anode 17. Accordingly, the metal sheet 22 functions as a current collector plate. When the metal sheet 22 functions as a current collector plate, the structure of the battery module 100 is such that a current is taken out of the electricity storage module 10 via the metal sheet 22. Thus, to enlarge the area of the metal sheet 22 enables a large current to be taken out. The metal sheet 22 is a member that is disposed over each end face of the electricity storage module 10, and thus, is easily enlarged in area.

Any metal may be appropriately used for the material of the metal sheet 22 according to the purpose without any particular limitations. For example, an electroconductive metal may be used. Examples of a metal as used herein include stainless steel, iron, copper, aluminum, titanium, and nickel.

The thickness of the metal sheet 22 is not particularly limited, and, for example, may be at least 10 μm, at least 50 μm, or at least 100 μm. The metal sheet 22 of a thickness less than 10 μm leads to difficulty in joining a side surface 22a thereof to an inner side surface 23a of the laminated sheet 23. The upper limit of this thicknesses is not particularly limited.

The thickness of the metal sheet may be at most 10 mm, at most 5 mm, or at most 1 mm in view of preventing the battery module 100 from upsizing. The metal sheet 22 may be thicker than the laminated sheet 23 in view of improving durability. Meanwhile, the metal sheet 22 may be thinner than the laminated sheet 23 in view of downsizing the battery module 100 to improve the energy density.

The area of the metal sheet 22 is not particularly limited, and may be at least 60% or at least 80% of the area of any of the current collectors 11 disposed over the end faces of the electricity storage module 10 in view of taking out a large current. The upper limit of this area is not particularly limited. The area of the metal sheet 22 may be at most 200%, at most 150%, at most 120%, or at most 100% of the area of any of the end faces of the electricity storage module 10 in view of preventing the battery module 100 from upsizing. The area of the metal sheet 22 is the area calculated from the outer shape thereof. The area of any of the current collectors 11 disposed over the end faces of the electricity storage module 10 is the area calculated from the exposed outer shape thereof.

The metal sheet 22 may be layered over each end face of the electricity storage module 10 directly or through any other members as long as electrically connected to the electricity storage module 10. For example, the metal sheet 22 may be layered on the electricity storage module 10 via an electroconductive elastic member. An electroconductive elastic member as used herein is not particularly limited. Examples of such a member include an elastic body made from a metal fiber, and an elastic body formed by mixing a carbon material and a resin.

The shape of the metal sheet 22 may be appropriately set according to the shape of each end face of the electricity storage module 10 without any particularly limitations. For example, the metal sheet 22 may be in the form of rectangular flat plate. As described later, a metal sheet with a protruding part may be used.

The metal sheet 22 functions not only as a current collector but also as a cooling plate. The metal sheet 22 has an aspect such that the area thereof can be enlarged as described above, which can also lead to better heat dissipation.

(Laminated Sheet 23)

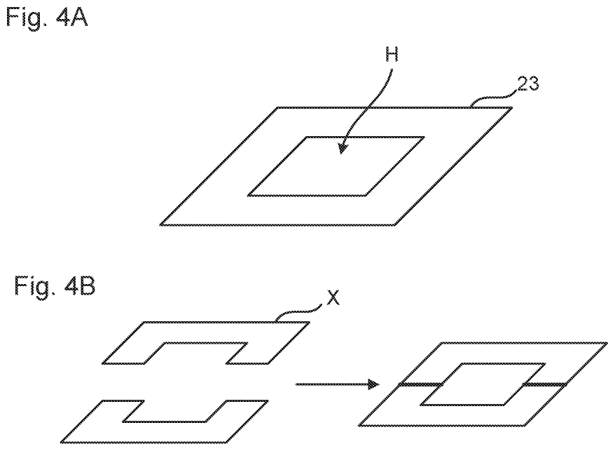

The laminated sheet 23 is a member disposed so as to surround the periphery of the metal sheet 22. The laminate sheet 23 has a hole H that is formed so as to fit the outer shape of the metal sheet 22 (FIG. 4A). The metal sheet 22 is disposed in the hole H. The metal sheet 22 and the laminated sheet 23 are joined to form each sheet-shaped structure 21.

Any known laminated sheet may be used for the laminated sheet 23, and an example thereof is a laminated sheet such that a first resin layer, a metal layer and a second resin layer are laminated in this order. A laminated sheet having such a structure is common. The first resin layer functions as a sealant layer and/or a protective layer, and is disposed over the outer surface of the metal layer. The material of the first resin layer may be a thermoplastic resin, and examples thereof include polyolefins such as polyethylene (PE) and polypropylene (PP); polyesters such as polyethylene terephthalate (PET); polystyrene; polyvinyl chloride; and polyamides such as nylon. The metal layer functions as a gas barrier layer, and is disposed between the first resin layer and the second resin layer. For example, the metal layer may be formed from a metal foil such as aluminum, iron, and stainless steel. The second resin layer functions as a sealant layer, and is disposed over the inner surface of the metal layer. That is, the second resin layer is used for joining with the other member. The second resin layer is formed from a thermoplastic resin. Examples of a thermoplastic resin as used herein include polyolefins such as polyethylene (PE) and polypropylene (PP); polyesters such as polyethylene terephthalate (PET); polystyrene; polyvinyl chloride and polyamides such as nylon. The thickness of the laminated sheet 23 is not particularly limited, and is at least 50 μm and less than 1 mm. The aforementioned trilayered laminated sheet is one example. A laminated sheet as used herein may have three or more layers. For example, a five-layered laminated sheet such that the first resin layer, a third resin layer, the metal layer, a fourth resin layer and the second resin layer are laminated in this order may be used. The materials of the third resin layer and the fourth resin layer may be appropriately set depending on the purpose.

Here, as shown in FIG. 4A, the laminated sheet 23 may be formed of one laminated sheet, and may be made by joining plural laminated sheets. For example, as shown in FIG. 4B, one may join a pair of laminated sheets X that are each half the size of the laminated sheet 23 taken along the length direction, and use the resultant as the laminated sheet 23.

(Sealing Structure of Housing 20)

The sealing structure of the housing 20 will be described. As shown in FIG. 2, the inner side surface 23a of the laminated sheet 23 (peripheral face of the hole H) is joined to the side surface 22a of the metal sheet 22. That is, each of the sheet-shaped structures 21 has a joining part 24 where the inner side surface 23a of the laminated sheet 23 and the side surface 22a of the metal sheet 22 are joined. The joining part 24 is formed all over the circumference of the inner side surface 23a of the laminated sheet 23 (side surface 22a of the metal sheet 22).

Outer circumferential parts 23b of the laminated sheets 23 of a pair of the sheet-shaped structures 21, 21 are directly joined to each other. That is, the housing 20 has a joining part 25 where the outer circumferential parts 23b of a pair of the laminated sheets 23 are joined. The joining part 25 is formed all along the outer circumferential parts 23b of the laminated sheets 23.

As described, the housing 20 has the joining parts 24 and 25, and thereby, the electricity storage module 10 is sealed therein. This can prevent gas and moisture from permeating the inside of the housing 20.

In the joining part 25 (along the outer circumferential parts 23b of the laminated sheets 23), the insulating properties of the respective laminated sheets 23 are ensured, and the metal layers included in the laminated sheets 23 are not in contact with each other. In view of further improving the insulating properties to suppress short circuits due to the contact of the metal layers with each other, the outer circumferential parts 23b of the laminated sheets 23 may be insulated (end portions are insulated). Since the process of insulating end portions is known, a detailed description thereof is omitted here. For example, the method disclosed in patent literature 2 may be appropriately employed.

<Another Embodiment of Battery Module 1>

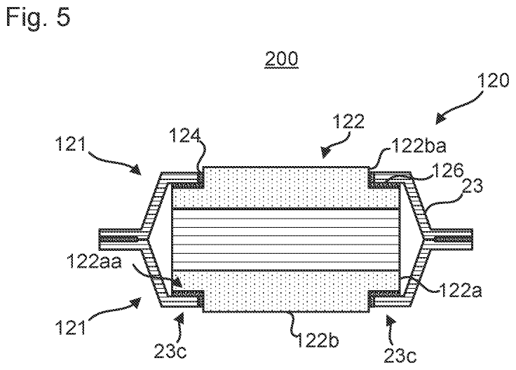

In the battery module 100, the metal sheets 22 in the form of flat plate are used. A battery module according to the present disclosure is not limited to this. For example, a metal sheet with a protruding part may be used. FIG. 5 is a cross-sectional view of a battery module 200 using metal sheets 122 with protruding parts.

As shown in FIG. 5, a housing 120 includes a pair of sheet-shaped structures 121, 121. The sheet-shaped structures 121 each include the metal sheet 122 with a protruding part, and the laminated sheet 23. Further, the metal sheet 122 includes a flat plate part 122a, and a protruding part 122b that protrudes outward in the thickness direction from the flat plate part 122a. The flat plate part 122a has an area larger than the protruding part 122b, and is disposed over each end face of the electricity storage module 10 in the thickness direction. Since the metal sheet 122 and the electricity storage module 10 are electrically connected, the protruding part 122b may be used as a terminal.

Here, the thickness of the metal sheet 122 will be described. The thickness of the metal sheet 122 is the total of thickness of the flat plate part 122a and the thickness of the protruding part 122b. The thickness of the metal sheet 122 is not particularly limited, and, for example, may be at least 20 μm, at least 100 μm, at least 200 μm, at least 10 mm, or at least 2 mm. The thickness of the flat plate part 122a is not particularly limited, and may be at least 10 μm, at least 50 μm, at least 100 μm, at least 5 mm, or at least 1 mm. The thickness of the protruding part 122b is not particularly limited, and may be at least 10 μm, at least 50 μm, at least 100 μm, at least 5 mm, or at least 1 mm.

The form of joining the metal sheet 122 and the laminated sheet 23 is as follows. As shown in FIG. 5, the inner side surface 23a of the laminated sheet 23 is joined to a side surface 122ba of the protruding part 122b (side face of the metal sheet 122). That is, each sheet-shaped structure 121 has a joining part 124 where the protruding part 122b (metal sheet 122) and the laminated sheet 23 are joined to each other. The joining part 124 is formed all over the periphery of the inner side surface 23a (side surface 122ba of the protruding part 122b) of the laminated sheet 23.

As shown in FIG. 5, an inner circumferential part 23c of the laminated sheet 23 may be joined to an outer circumferential part 122aa of the flat plate part 122a. In other words, each of the sheet-shaped structures 121 may have a joining part 126 where the flat plate part 122a and the laminated sheet 23 are joined to each other. The joining part 126 is formed all along the inner circumferential part 23c of the laminated sheet 23 (outer circumferential part 122aa of the flat plate part 122a). As described, when each of the sheet-shaped structures 121 further has the joining part 126, the metal sheet 122 can be firmly joined to the laminated sheet 23.

<Another Embodiment of Battery Module 2>

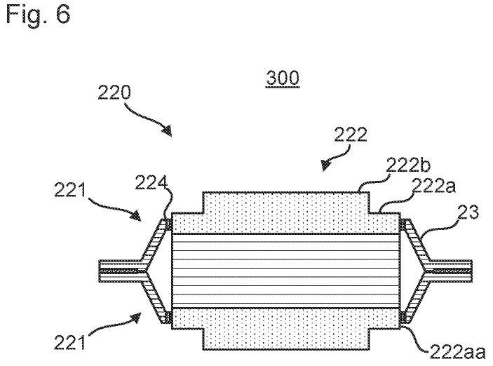

Another embodiment of the battery module using a metal sheet with a protruding part will be further described. FIG. 6 is a cross-sectional view of a battery module 300 that is the other embodiment.

As shown in FIG. 6, a housing 220 includes a pair of sheet-shaped structures 221, 221. The sheet-shaped structures 221 each include a metal sheet 222 with a protruding part, and the laminated sheet 23. Further, the metal sheet 222 includes a flat plate part 222a, and a protruding part 222b that protrudes outward in the thickness direction from the flat plate part 222a. One or a plurality of the protruding part(s) 222b may be included. As the number of the protruding parts 222b is larger, the surface area of the metal sheet 222 is larger and the heat dissipates to a greater degree. The descriptions on the thickness of the metal sheet 122 is applicable to the metal sheet 222.

The form of joining the metal sheet 222 and the laminated sheet 23 is as follows. As shown in FIG. 6, the inner side surface 23a of the laminated sheet 23 is joined to a side surface 222aa of the flat plate part 222a (side face of the metal sheet 222). That is, each sheet-shaped structure 221 has a joining part 224 where the flat plate part 222a (metal sheet 222) and the laminated sheet 23 are joined to each other. The joining part 224 is formed all over the periphery of the inner side surface 23a (side surface 222aa of the flat plate part 222a) of the laminated sheet 23.

<Another Embodiment of Battery Module 3>

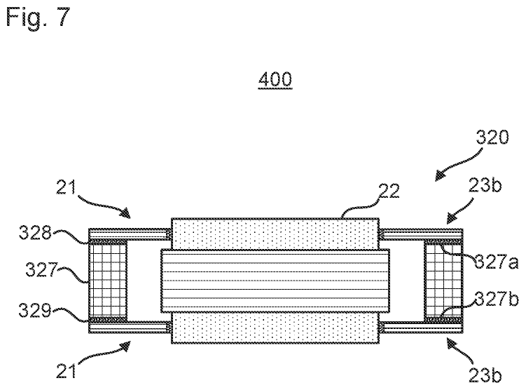

In the battery module 100, the outer circumferential parts 23b of the laminated sheets 23 of a pair of the sheet-shaped structures 21, 21 are directly joined to each other. A battery module according to the present disclosure is not limited to this embodiment. The outer circumferential parts of the laminated sheets may be joined indirectly to each other via another member. FIG. 7 is a cross-sectional view of a battery module 400.

A housing 320 includes, in addition to a pair of the sheet-shaped structures 21, 21, a frame-shaped member 327 that is disposed so as to surround the periphery of the electricity storage module 10. The material of the frame-shaped member 327 is not particularly limited, and an example thereof is a laminated sheet such as an aluminum laminated sheet. The frame-shaped member 327 can be obtained by molding such a laminated sheet into the shape of frame. The size of the frame-shaped member 327 is not particularly limited as long as the periphery of the electricity storage module 10 can be surrounded. The thickness of the frame-shaped member 327 is not particularly limited, and may be at least the thickness of the electricity storage module 10.

In the housing 320, the outer circumferential part 23b of the laminated sheet 23 of one of the sheet-shaped structures 21, 21 is joined to one face 327a of the frame-shaped member 327 in the thickness direction, and the outer circumferential part 23b of the laminated sheet 23 of the other sheet-shaped structure 21 is joined to another face 327b of the frame-shaped member 327. That is, the housing 320 has a joining part 328 where the outer circumferential part 23b of one of the laminated sheets 23 and the one face 327a of the frame-shaped member 327 in the thickness direction are joined to each other, and a joining part 329 where the outer circumferential part 23b of the laminated sheets 23 and the other face 327b of the frame-shaped member 327 in the thickness direction are joined to each other. The joining parts 328 and 329 are formed all along the outer circumferential parts 23b (all around the circumferences of the faces 327a and 327b of the frame-shaped member 327) of the one and the other laminated sheets 23. This enables the electricity storage module 10 to be sealed in the housing 320.

The housing 320 includes the frame-shaped member 327, and thereby, has the following aspects. For example, when the housing has no frame-shaped member, vacuum sealing of the housing in production causes stress to concentrate on the corners formed at the laminated sheets. Further, the laminated sheets repeatedly expand and contract due to heat in the use of the battery, which causes stress to further concentrate on the corners. The corners may be worn and frayed by such stress concentration to break. In contrast, the housing 320 includes the frame-shaped member 327, and thereby, has no corner at the laminated sheets 327, which can suppress such breakage. Also, the housing 320 includes the frame-shaped member 327, and thereby, can have a smaller outer shape to improve the energy density of the entire battery module 400.

The plural embodiments of the battery module according to the present disclosure have been described. The battery module according to the present disclosure enables a large current to be taken out thereof, and can prevent gas and moisture from permeating the inside of the housing with a simple structure. Further, the battery module according to the present disclosure can be easily produced since the metal sheets are members different from the laminated sheets, and the sheet-shaped structures can be easily formed by joining these sheets.

The electricity storage module disclosed in patent literature 2 will be compared. In the electricity storage module of patent literature 2, laminated sheets are directly joined to a sealing member of an electrode stack. Thus, it is necessary that resin layers of the laminated sheets be compatible with the sealing member. That is, material options are limited. Further, because the laminated sheets are directly heat-welded to the sealing member, the structure of the sealing member may collapse in heating, so that an electrolytic solution leaks. In contrast, in the battery module according to the present disclosure, the laminated sheets are not directly joined to the electricity storage module. Thus, material options are broad. Further, there is no risk that the electrolytic solution inside the electricity storage module leaks in joining.

Further, the electricity storage module disclosed in patent literature 3 will be compared. The electricity storage module disclosed in patent literature 3 uses, as a housing, laminated sheets such that metal layers are exposed. In order to expose the metal layers, solvent treatment, heat treatment, flame treatment, or the like is performed. In contrast, in the battery module according to the present disclosure, the sheet-shaped structures can be easily formed by using the metal sheets, and the laminated sheets that are members different from the metal sheets, and joining these sheets. Therefore, the battery module according to the present disclosure can be easily produced.

The plural embodiments of the battery module have been each described above. These respective embodiments may be used in combination. For example, one may include the frame-shaped member in the components of the housing while using the metal sheets with protruding parts.

[Method of Producing Battery Module]

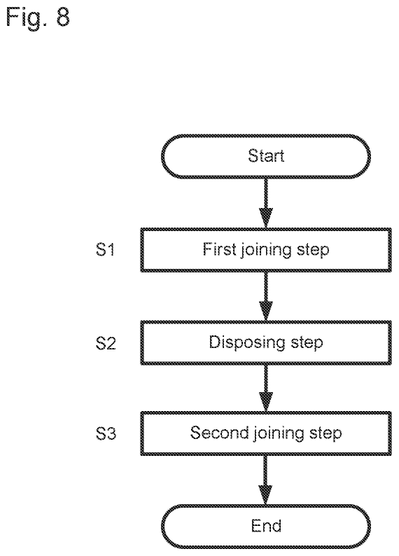

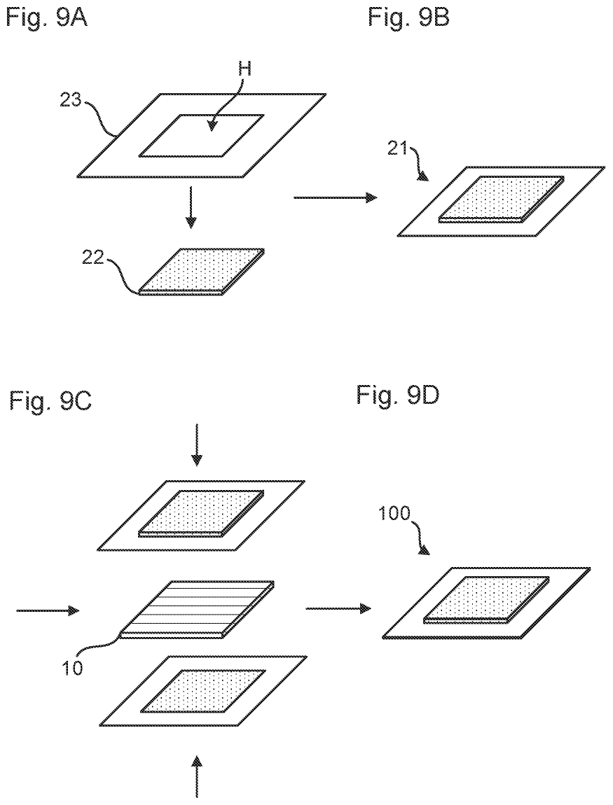

A method of producing the battery module 100 which is one embodiment of the method of producing a battery module according to the present disclosure will be described. FIG. 8 is a flowchart of the method of producing the battery module 100. FIGS. 9A to 9D are schematic views for the method of producing the battery module 100.

The method of producing the battery module 100 comprises: a first joining step S1 of disposing the laminated sheet 23 around the metal sheet 22, and joining the inner side surface 23a of the laminated sheet 23 and the side surface 22a of the metal sheet 22 to obtain the sheet-shaped structure 21; a disposing step S2 of holding, by a pair of the sheet-shaped structures 21, 21, the electricity storage module 10 that is formed by alternately layering electrodes and separators on both sides in the thickness direction, and disposing the metal sheets 22 over the end faces of the electricity storage module 10 in the thickness direction; and a second joining step S3 of directly joining the outer circumferential parts 23b of the laminated sheets 23 of a pair of the sheet-shaped structures 21, 21 to each other after the disposing step S2.

<First Joining Step S1>

The joining step S1 is the step of disposing the laminated sheet 23 around the metal sheet 22, and joining the inner side surface 23a of the laminated sheet 23 and the side surface 22a of the metal sheet 22 to obtain the sheet-shaped structure 21. FIGS. 9A and 9B correspond to the first joining step S1. Specifically, first, the metal sheet 22 is disposed in the hole H of the laminated sheet 23. Next, the inner side surface 23a of the laminated sheet 23 and the side surface 22a of the metal sheet 22 are joined to form the joining part 24. According to this, the sheet-shaped structure 21 is obtained. The method of joining the inner side surface 23a of the laminated sheet 23 and the side surface 22a of the metal sheet 22 is not particularly limited, and may be by heat welding or by laser welding. The inner side surface 23a and the side surface 22a may be joined with an adhesive.

<Disposing Step S2>

The disposing step S2 is performed after the first joining step S1, and is the step of holding, by a pair of the sheet-shaped structures 21, 21, the electricity storage module 10 that is formed by alternately layering plural electrodes and plural separators on both sides in the thickness direction, and disposing the metal sheets 22 over the end faces of the electricity storage module 10 in the thickness direction. FIG. 9C corresponds to the disposing step S2. When the metal sheets 22 are disposed over the end faces of the electricity storage module 10 in the thickness direction via other members, the other members are each disposed among the metal sheets 22 and the electricity storage module 10 in the disposing step S2.

<Second Joining Step S3>

The second joining step S3 is the step of directly joining the outer circumferential parts 23b of the laminated sheets 23 of a pair of the sheet-shaped structures 21, 21 to each other after the disposing step S2. FIG. 9D corresponds to the second joining step S3. This can cause the electricity storage module 10 to be sealed in the housing 20.

The method of directly joining the outer circumferential parts 23b of the laminated sheets 23 is not particularly limited, and may be by heat welding or by laser welding. The outer circumferential parts 23b may be joined to each other with an adhesive. The second joining step S3 may be performed in the atmosphere, and may be performed in a vacuum atmosphere. For example, one may perform the second joining step S3 while a vacuum is drawn inside the housing 20, and seal the electricity storage module 10 in the housing 20.

The electricity storage module 10 where a nonaqueous electrolyte was poured in advance may be used. Alternatively, an electrolyte solution may be poured into the electricity storage module 10 in the second joining step S3. For example, one may provide, at a side face of the electricity storage module 10, an inlet for electrolytic solution which extends to the outside of the housing 20, and pour a nonaqueous electrolyte into the electricity storage module 10 via this inlet.

<Another Embodiment of Method of Producing Battery Module 1>

A method of producing the battery module 200 which is another embodiment will be described. The method of producing the battery module 100 and the method of producing the battery module 200 differ from each other only in first joining step, but the other steps therein are the same.

In the method of producing the battery module 100, the inner side surface 23a of the laminated sheet 23 and the side surface 22a of the metal sheet 22 in the form of flat plate are joined in the first joining step S1. In contrast, in the method of producing the battery module 200, the inner side surface 23a of the laminated sheet 23 and the side surface 122ba of the protruding part 122b provided on the metal sheet 122 are joined in the first joining step. In the first joining step, the inner circumferential part 23c of the laminated sheet 23 and the outer circumferential part 122aa of the flat plate part 122a may be also joined. This allows the metal sheet 122 and the laminated sheet 23 to be firmly joined. The method of joining the inner circumferential part 23c of the laminated sheet 23 and the outer circumferential part 122aa of the flat plate part 122a is not particularly limited, and may be by heat welding or by laser welding. The inner circumferential part 23c and the outer circumferential part 122aa may be joined with an adhesive.

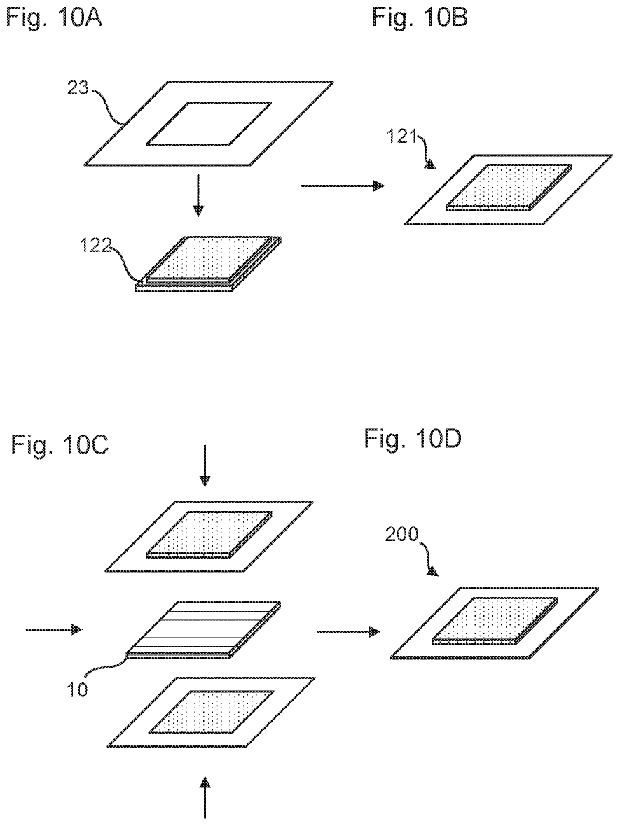

FIGS. 10A to 10D are schematic views for the method of producing the battery module 200. As shown in FIGS. 10A to 10D, the sheet-shaped structure 121 is obtained by the first joining step with the metal sheet 122 and the laminated sheet 23. The battery module 200 is obtained by the disposing step and the second joining step with a pair of the sheet-shaped structures 121 and the electricity storage module 10.

<Another Embodiment of Method of Producing Battery Module 2>

A method of producing the battery module 300 which is another embodiment will be described. The method of producing the battery module 100 and the method of producing the battery module 300 differ from each other only in first joining step, but the other steps therein are the same.

In the method of producing the battery module 100, the inner side surface 23a of the laminated sheet 23 and the side surface 22a of the metal sheet 22 in the form of flat plate are joined in the first joining step S1. In contrast, in the method of producing the battery module 300, the inner side surface 23a of the laminated sheet 23 and the side surface 222aa of the flat plate part 222a provided on the metal sheet 222 are joined in the first joining step.

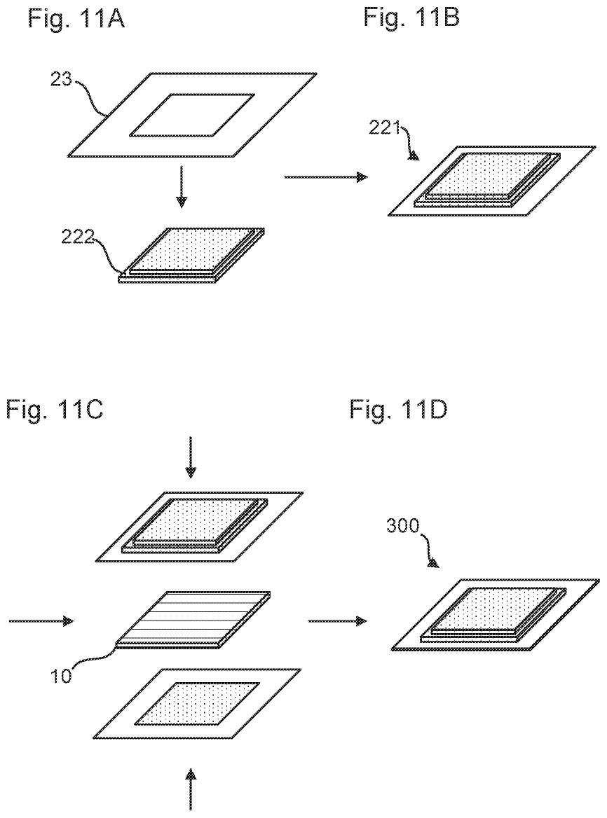

FIGS. 11A to 11D are schematic views for the method of producing the battery module 300. As shown in FIGS. 11A to 11D, the sheet-shaped structure 221 is obtained by the first joining step with the metal sheet 222 and the laminated sheet 23. The battery module 300 is obtained by the disposing step and the second joining step with a pair of the sheet-shaped structures 221 and the electricity storage module 10.

<Another Embodiment of Method of Producing Battery Module 3>

A method of producing the battery module 400 which is another embodiment will be described. The method of producing the battery module 100 and the method of producing the battery module 400 differ from each other only in disposing step and second joining step, but the other step therein is the same.

In the method of producing the battery module 100, the electricity storage module 10 is held between a pair of the sheet-shaped structures 23 in the thickness direction, and the metal sheets 22 are disposed over the end faces of the electricity storage module 10 in the thickness direction in the disposing step S2; and the outer circumferential parts 23b of the laminated sheets 23 are directly joined to each other in the second joining step S3. In contrast, in the method of producing the battery module 400, the electricity storage module 10 is held between a pair of the sheet-shaped structures 23 in the thickness direction via the frame-shaped member 327 that surrounds the periphery of the electricity storage module 10, and the metal sheets 22 are disposed over the end faces of the electricity storage module 10 in the thickness direction in the disposing step; and the outer circumferential part 23b of the laminated sheet 23 of one of a pair of the sheet-shaped structures 21, 21 and the one face 327a of the frame-shaped member 327 in the thickness direction are joined, and the outer circumferential part 23b of the laminated sheet 23 of the other sheet-shaped structure 21 and the other face 327b of the frame-shaped member 327 are joined in the second joining step. The method of joining the laminated sheets 23 and the frame-shaped member 327 is not particularly limited, and may be by heat welding or by laser welding. The laminated sheets 23 and the frame-shaped member 327 may be joined with an adhesive.

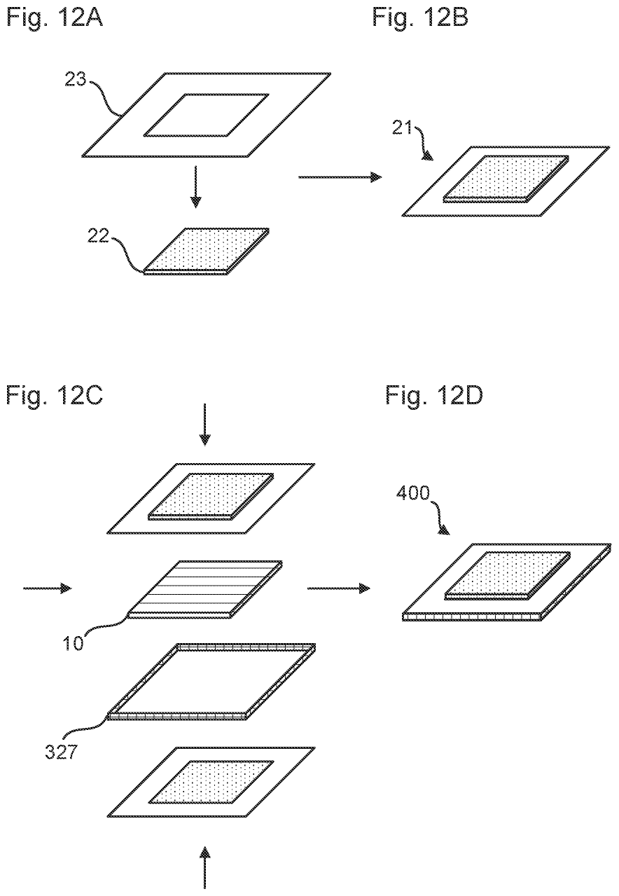

FIGS. 12A to 12D are schematic views for the method of producing the battery module 400. As shown in FIGS. 12A to 12D, the sheet-shaped structure 21 is obtained by the first joining step with the metal sheet 22 and the laminated sheet 23. The battery module 400 is obtained by the disposing step and the second joining step with a pair of the sheet-shaped structures 21, the electricity storage module 10, and the frame-shaped member 327.

The plural embodiments of the method of producing a battery module according to the present disclosure have been described. The method of producing a battery module according to the present disclosure enables the electricity storage module to be sealed in the housing with simple steps, and a battery module of which a large current can be taken out to be produced.

The plural embodiments of the method of producing a battery module have been described above. These respective embodiments may be used in combination. For example, one may perform the first joining step with the metal sheets with the protruding parts, and the second joining step with the frame-shaped member.

### REFERENCE SIGNS LIST

10 electricity storage module
11 current collector
12 cathode layer
13 anode layer
14 bipolar electrode
15 separator
16 end part cathode
17 end part anode
18 electrode stack
19 sealing member
20, 120, 220, 320 housing
21, 121, 221, 321 sheet-shaped structure
22, 122, 222 metal sheet
22a side surface
122a, 222a flat plate part
122aa outer circumferential part
222aa side surface
122b, 222b protruding part
122ba side surface
23 laminated sheet
23a inner side surface
23b outer circumferential part
23c inner circumferential part
24, 124, 224 joining part
25 joining part
126 joining part
327 frame-shaped member
327a face
327b face
328 joining part
329 joining part
100, 200, 300, 400 battery module
H hole
X laminated sheet

What is claimed is:

1. A battery module comprising:
an electricity storage module formed by alternately layering electrodes and electrolyte layers; and
a housing that houses the electricity storage module therein, wherein
the housing has a pair of sheet-shaped structures that are disposed so as to hold the electricity storage module on both sides in a thickness direction,
the sheet-shaped structures each include a metal sheet that is disposed over an end face of the electricity storage module in the thickness direction, and a laminated sheet that is disposed so as to surround a periphery of the metal sheet,
the metal sheet is electrically connected to the electricity storage module,
an inner side surface of the laminated sheet is joined to a side surface of the metal sheet, and
in a pair of the sheet-shaped structures, outer circumferential parts of the laminated sheets are directly or indirectly joined to each other.

2. The battery module according to claim 1, wherein
the housing includes a frame-shaped member that is disposed so as to surround a periphery of the electricity storage module, and
the outer circumferential part of the laminated sheet of one of a pair of the sheet-shaped structures is joined to one face of the frame-shaped member, and the outer circumferential part of the laminated sheet of the other one of the sheet-shaped structures is joined to another face of the frame-shaped member.

3. The battery module according to claim 1, wherein the metal sheet is thicker than the laminated sheet.

4. The battery module according to claim 1, wherein the electricity storage module is a bipolar electricity storage module.

5. A method of producing a battery module, the method comprising:
first joining of disposing a laminated sheet around a metal sheet, and joining an inner side surface of the laminated sheet and a side surface of the metal sheet to obtain a sheet-shaped structure;
disposing of holding, by a pair of the sheet-shaped structures, an electricity storage module that is formed by alternately layering electrodes and separators in a thickness direction, and disposing the metal sheets over end faces of the electricity storage module in the thickness direction; and
second joining of directly or indirectly joining outer circumferential parts of the laminated sheets of a pair of the sheet-shaped structures to each other after said disposing.
